(19) United States
(12) Patent Application Publication
(10) Pub. No.: US 2022/0390249 A1
(43) Pub. Date: Dec. 8, 2022

(54) METHOD AND APPARATUS FOR GENERATING DIRECTION IDENTIFYING MODEL, DEVICE, MEDIUM, AND PROGRAM PRODUCT

(71) Applicant: Beijing Baidu Netcom Science Technology Co., Ltd., Beijing (CN)

(72) Inventors: Lingling LIU, Beijing (CN); Gaopeng MO, Beijing (CN); Wei Ma, Beijing (CN)

(21) Appl. No.: 17/889,252

(22) Filed: Aug. 16, 2022

Related U.S. Application Data
(63) Continuation of application No. PCT/CN2021/142310, filed on Dec. 29, 2021.

(30) Foreign Application Priority Data
Jun. 30, 2021 (CN) 202110737838.9

(51) Int. Cl. G01C 21/36; G06N 20/00

(52) U.S. Cl. CPC G01C 21/3632; G06N 20/00

(57) ABSTRACT

A method and apparatus for generating a direction identifying model, a device, a medium, and a program product are provided. The method includes: acquiring direction-targeted road test data corresponding to a target road, and a guide arrow sign and an accessible road-direction corresponding to the target road; and training a machine learning model by using the road test data and the guide arrow sign as an input of the direction identifying model, and using the accessible road-direction as an output of the direction identifying model, to obtain the direction identifying model.

### CROSS-REFERENCE TO RELATED APPLICATIONS

The present patent application is a continuation of International Application No. PCT/CN2021/142310, filed on Dec. 29, 2021, which claims priority to Chinese Patent Application No. 202110737838.9 titled “METHOD AND APPARATUS FOR GENERATING DIRECTION IDENTIFYING MODEL, MEDIUM, AND PROGRAM PRODUCT” filed on Jun. 30, 2021, the full text of which is incorporated herein by reference. Both of the aforementioned applications are hereby incorporated by reference in their entireties.

### TECHNICAL FIELD

The present disclosure relates to the field of computers, specifically relates to the field of artificial intelligence such as deep learning, autonomous driving, intelligent transport, and knowledge graph, and more specifically relates to a method and apparatus for generating a direction identifying model, a device, a medium, and a program product.

### BACKGROUND

With the continuous development of intelligent transport, applying an artificial intelligence technology to identification of road information has attracted more and more attention, e.g., the identification of traffic signs such as guide arrows. A guide arrow contains important road information, intelligent identification thereof is of great significance for intelligent transport.

### SUMMARY

Embodiments of the present disclosure present a method for generating a direction identifying model, an apparatus for generating a direction identifying model, a device, a medium, and a program product.

In a first aspect, an embodiment of the present disclosure presents a method for generating a direction identifying model, including: acquiring direction-targeted road test data corresponding to a target road, and a guide arrow sign and an accessible road-direction corresponding to the target road; and training a machine learning model by using the road test data and the guide arrow sign as an input of the direction identifying model, and using the accessible road-direction as an output of the direction identifying model, to obtain the direction identifying model.

In a second aspect, an embodiment of the present disclosure presents an apparatus for generating a direction identifying model, including: a data acquiring module configured to acquire direction-targeted road test data corresponding to a target road, and a guide arrow sign and an accessible road-direction corresponding to the target road; and a model training module configured to train a machine learning model by using the road test data and the guide arrow sign as an input of the direction identifying model, and using the accessible road-direction as an output of the direction identifying model, to obtain the direction identifying model.

In a third aspect, an embodiment of the present disclosure presents a method for identifying an accessible road-direction, including: acquiring a guide arrow sign and direction-targeted road test data corresponding to a to-be-predicted road; and inputting the guide arrow sign and the direction-targeted road test data corresponding to the to-be-predicted road into the direction identifying model according to the first aspect, to obtain an accessible road-direction corresponding to the to-be-predicted road.

In a fourth aspect, an embodiment of the present disclosure presents an apparatus for identifying an accessible road-direction, including: a data acquiring module configured to acquire a guide arrow sign and direction-targeted road test data corresponding to a to-be-predicted road; and a direction obtaining module configured to input the guide arrow sign and the direction-targeted road test data corresponding to the to-be-predicted road into the direction identifying model according to the first aspect, to obtain an accessible road-direction corresponding to the to-be-predicted road.

In a fifth aspect, an embodiment of the present disclosure presents an electronic device, including: at least one processor; and a memory communicatively connected to the at least one processor; where the memory stores instructions executable by the at least one processor, and the instructions are executed by the at least one processor, such that the at least one processor can execute the method according to the first aspect or the second aspect.

In a sixth aspect, an embodiment of the present disclosure presents a non-transitory computer readable storage medium storing computer instructions, where the computer instructions are used for causing a computer to execute the method according to the first aspect or the second aspect.

In a seventh aspect, an embodiment of the present disclosure presents a computer program product including a computer program, where the computer program, when executed by a processor, implements the method according to the first aspect or the second aspect.

In an eighth aspect, an embodiment of the present disclosure presents a roadside device, including the electronic device according to the fifth aspect.

In a ninth aspect, an embodiment of the present disclosure presents a cloud control platform, including the electronic device according to the fifth aspect.

It should be understood that contents described in the SUMMARY are neither intended to identify key or important features of embodiments of the present disclosure, nor intended to limit the scope of the present disclosure. Other features of the present disclosure will become readily understood with reference to the following description.

### BRIEF DESCRIPTION OF THE DRAWINGS

After reading detailed descriptions of non-limiting embodiments with reference to the following accompanying drawings, other features, objectives, and advantages of the present disclosure will become more apparent. The drawings are used for better understanding of the present solution, and do not impose any limitation on the scope of protection of the present disclosure. In the drawings:

FIG. 1 is a diagram of an exemplary system architecture in which embodiments of the present disclosure may be implemented;

FIG. 2 is a flowchart of a method for generating a direction identifying model according to an embodiment of the present disclosure;

FIG. 3 is a flowchart of the method for generating a direction identifying model according to an embodiment of the present disclosure;

FIG. 4 is a schematic diagram of determining an accessible road-direction;

FIG. 5 is a flowchart of a method for identifying an accessible road-direction according to an embodiment of the present disclosure;

FIG. 6 is a schematic diagram of data storage;

FIG. 7 is a schematic structural diagram of an apparatus for generating a direction identifying model according to an embodiment of the present disclosure;

FIG. 8 is a schematic structural diagram of an apparatus for identifying an accessible road-direction according to an embodiment of the present disclosure; and

FIG. 9 is a block diagram of an electronic device configured to implement embodiments of the present disclosure.

### DETAILED DESCRIPTION OF EMBODIMENTS

Example embodiments of the present disclosure are described below with reference to the accompanying drawings, including various details of the embodiments of the present disclosure to contribute to understanding, which should be considered merely as examples. Therefore, those of ordinary skills in the art should realize that various alterations and modifications may be made to the embodiments described here without departing from the scope and spirit of the present disclosure. Similarly, for clearness and conciseness, descriptions of well-known functions and structures are omitted in the following description.

It should be noted that the embodiments in the present disclosure and the features in the embodiments may be combined with each other on a non-conflict basis. The present disclosure will be described in detail below with reference to the drawings and in combination with the embodiments.

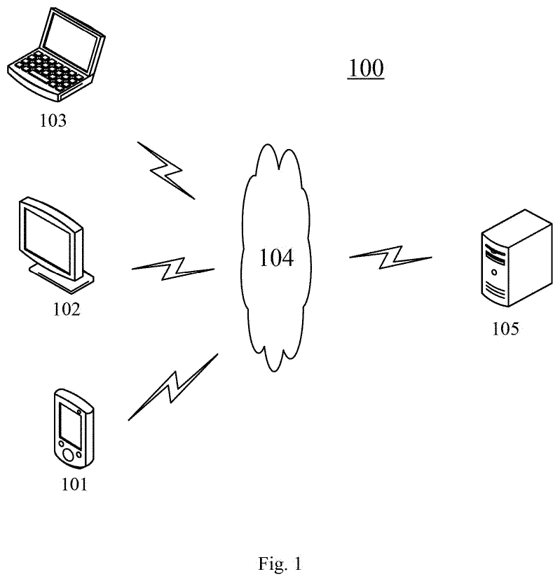

FIG. 1 shows an exemplary system architecture 100 in which a method for generating a direction identifying model or an apparatus for generating a direction identifying model or a method and apparatus for identifying an accessible road-direction of embodiments of the present disclosure may be implemented.

As shown in FIG. 1, the system architecture 100 may include terminal devices 101, 102, and 103, a network 104, and a server 105. The network 104 serves as a medium providing a communication link between the terminal devices 101, 102, and 103, and the server 105. The network 104 may include various types of connections, such as wired or wireless communication links, or optical cables.

A user may interact with the server 105 using the terminal devices 101, 102, and 103 via the network 104, e.g., to-be-processed data. The terminal devices 101, 102, and 103 may be provided with various client applications and intelligent interaction applications, such as a navigation processing application and map software.

The terminal devices 101, 102, and 103 may be hardware, or may be software. When the terminal devices 101, 102, and 103 are hardware, the terminal devices may be electronic products, e.g., a PC (personal computer), a mobile phone, a smart phone, a PDA (personal digital assistant), a wearable device, a PPC (pocket PC), a tablet computer, a smart vehicle terminal, a smart TV, a smart speaker, a tablet computer, a laptop portable computer, and a desktop computer, that perform man-machine interactions with the user by one or more approaches, such as a keyboard, a touch panel, a display screen, a touch screen, a remote controller, or a voice interaction or handwriting device. When the terminal devices 101, 102, and 103 are software, the terminal devices may be installed in the above electronic devices, or may be implemented as a plurality of software programs or software modules, or may be implemented as a single software program or software module. This is not specifically limited here.

The server 105 may provide various services. For example, when receiving a data processing request sent from the terminal devices 101, 102, and 103, the server 105 may acquire a configuration file corresponding to to-be-processed data, where the data processing request is used for instructing to process the to-be-processed data using the configuration file; analyze the configuration file to obtain an analysis result; and process the to-be-processed data using data processing measures in the analysis result.

It should be noted that the server 105 may be hardware, or may be software. When the server 105 is hardware, the server may be implemented as a distributed server cluster composed of a plurality of servers, or may be implemented as a single server. When the server 105 is software, the server may be implemented as a plurality of software programs or software modules (e.g., software programs or software modules for providing distributed services), or may be implemented as a single software program or software module. This is not specifically limited here.

It should be noted that the method for generating a direction identifying model or the method for identifying an accessible road-direction provided in embodiments of the present disclosure is generally executed by the server 105. Accordingly, the apparatus for generating a direction identifying model or the apparatus for identifying an accessible road-direction is generally provided in the server 105.

It should be understood that the numbers of terminal devices, networks, and servers in FIG. 1 are merely illustrative. Any number of terminal devices, networks, and servers may be provided based on actual requirements.

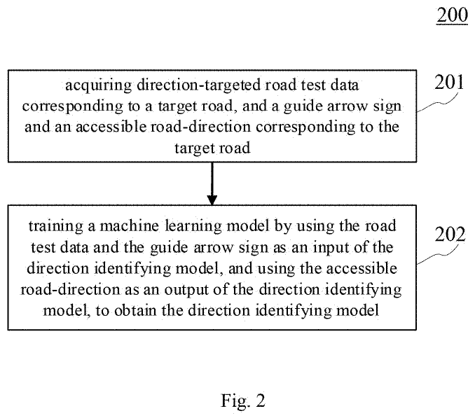

Further referring to FIG. 2, a process 200 of a method for generating a direction identifying model according to an embodiment of the present disclosure is shown. The method for generating a direction identifying model may include the following steps.

Step 201: acquiring direction-targeted road test data corresponding to a target road, and a guide arrow sign and an accessible road-direction corresponding to the target road.

In the present embodiment, an executing body (e.g., the terminal devices 101, 102, and 103, or the server 105 shown in FIG. 1) of the method for generating a direction identifying model may acquire the direction-targeted road test data corresponding to the target road, and the guide arrow sign and the accessible road-direction corresponding to the target road. The target road may be a road in an actual road network or a road in an electronic map. The direction-targeted road test data may be direction-associated road test data, and the road test data may be data obtained by detecting the target road by various approaches, such as data collected by a long-range radar, a lidar, or an ultrasonic sensor of an autonomous vehicle. The guide arrow sign and the accessible road-direction may be a printed sign on the target road, or bound to the target road and displayed on an interface of a navigation application of a terminal device (for example, the terminal devices 101, 102, and 103 shown in FIG. 1).

Accordingly, in this example, the guide arrow sign may be used for instructing a traffic participant on the target road to travel in accordance with the guide arrow sign, and is mainly used for providing the traffic participant with guide-related information. The guide arrow sign may be used for guiding, warning, regulating, or instructing traffic. The guide arrow sign gives accurate road traffic information to the traffic participant, such that road traffic is smooth and safe with low pollution and energy saving.

It should be noted that the guide arrow sign may be a guide arrow sign in an image.

The accessible road-direction may be used for indicating a travelling direction of the traffic participant at a next moment (i.e., a moment next to a current moment). The traffic participant may be any object participating in traffic, such as a car, a taxi, a bus, or a pedestrian.

In the technical solutions of the present disclosure, the acquisition, storage, application, and the like of the direction-targeted road test data, the guide arrow sign, and the accessible road-direction involved are in conformity with relevant laws and regulations, and do not violate public order and good customs.

Step 202: training a machine learning model by using the road test data and the guide arrow sign as an input of the direction identifying model, and using the accessible road-direction as an output of the direction identifying model, to obtain the direction identifying model.

In the present embodiment, after obtaining the road test data, the guide arrow sign, and the accessible road-direction corresponding to the target road, the executing body may train the machine learning model using the road test data, the guide arrow sign, and the accessible road-direction, to obtain the direction identifying model. During the training, the executing body may use the road test data and the guide arrow sign as the input of the direction identifying model, and use the accessible road-direction corresponding to the input as a desired output, to obtain the direction identifying model. The machine learning model may be a probability model, a classification model, or other classifiers in an existing technology or a technology to be developed in the future. For example, the machine learning model may include any one of the following models: a decision tree model (XGBoost), a logistic regression model (LR), and a deep neural network model (DNN).

In an example, after the road test data and the guide arrow sign are obtained, feature extraction is performed on the road test data and the guide arrow sign, to obtain a directional feature; and then, model training is performed using the directional feature and the accessible road-direction. The directional feature may be a feature for characterizing a direction in the road test data and the guide arrow sign.

It should be noted that the directional feature may be extracted by a pre-trained feature extracting model.

In the method for generating a direction identifying model provided in the embodiment of the present disclosure first direction-targeted road test data corresponding to a target road, and a guide arrow sign and an accessible road-direction corresponding to the target road are acquired; and finally a machine learning model is trained by using the road test data and the guide arrow sign as an input of the direction identifying model, and using the accessible road-direction as an output of the direction identifying model, to obtain the direction identifying model. The model training may be performed using multi-dimensional data of the target road, i.e., the model training may be performed using the direction-targeted road test data, the guide arrow sign, and the accessible road-direction corresponding to the target road, to obtain the direction identifying model, thereby improving an identification precision of the direction identifying model.

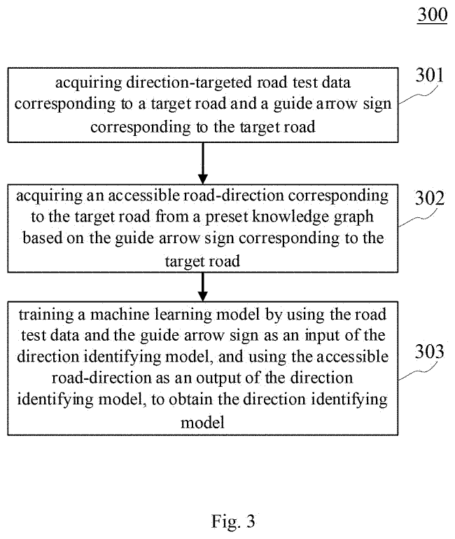

Further referring to FIG. 3, FIG. 3 shows a process 300 of the method for generating a direction identifying model according to an embodiment of the present disclosure. The method for generating a direction identifying model may include the following step 301 to step 303.

Step 301: acquiring direction-targeted road test data corresponding to a target road and a guide arrow sign corresponding to the target road.

In the present embodiment, an executing body (e.g., the terminal devices 101, 102, and 103, or the server 105 shown in FIG. 1) of the method for generating a direction identifying model may acquire the direction-targeted road test data corresponding to the target road and the guide arrow sign corresponding to the target road from a road network or an electronic map.

It should be noted that the target road generally corresponds to a plurality of guide arrow signs, and the guide arrow sign corresponding to the target road may be any one guide arrow sign among the plurality of guide arrow signs.

Step 302: acquiring an accessible road-direction corresponding to the target road from a preset knowledge graph based on the guide arrow sign corresponding to the target road.

In the present embodiment, the executing body may acquire the accessible road-direction corresponding to the target road from the preset knowledge graph based on the target road and the guide arrow sign. The preset knowledge graph may be established by using the guide arrow sign and the accessible road-direction corresponding to the target road as entities, and based on a relationship between the guide arrow sign and the accessible road-direction.

It should be noted that based on the guide arrow sign and the accessible road-direction, a traveling direction of a traffic participant on the target road at a next moment can be guided, to remind the traffic participant, through the travelling direction, to operate a transportation means in accordance with the travelling direction. The transportation means may be a means participating in traffic, such as a bicycle, a bus, or a taxi.

Step 303: training a machine learning model by using the road test data and the guide arrow sign as an input of the direction identifying model, and using the accessible road-direction as an output of the direction identifying model, to obtain the direction identifying model.

In the present embodiment, specific operations in step 303 have been introduced in detail in step 202 in the embodiment shown in FIG. 2. The description will not be repeated here.

As can be seen from FIG. 3, compared with the corresponding embodiment of FIG. 2, the method for generating a direction identifying model in the present embodiment highlights the step of determining the accessible road-direction. Therefore, the solution according to the present embodiment acquires the accessible road-direction corresponding to the target road from the preset knowledge graph based on the guide arrow sign corresponding to the target road. Based on the guide arrow sign corresponding to the target road and the accessible road-direction, the travelling direction of the traffic participant on the target road at the next moment can be guided, such that the traffic participant can learn about a correct travelling direction in advance, thereby improving the traffic safety.

In some optional implementations of the present embodiment, before acquiring the accessible road-direction corresponding to the target road from the preset knowledge graph based on the guide arrow sign corresponding to the target road, the method for generating a direction identifying model further includes:

establishing the knowledge graph by using the guide arrow sign and the accessible road-direction corresponding to the target road as the entities, and based on the relationship between the guide arrow sign and the accessible road-direction.

In the present implementation, the executing body may establish the knowledge graph by using the guide arrow sign and the accessible road-direction as entities of the knowledge graph respectively, and using the relationship between the guide arrow sign and the accessible road-direction as the relationship between the entities of the knowledge graph.

It should be noted that the entities of the knowledge graph include, but are not limited to, the guide arrow sign and the accessible road-direction.

Here, the knowledge graph is a network that presents relationships between the entities, i.e., the knowledge graph may include a plurality of entities and the relationships between the entities. For example, both the guide arrow sign and the accessible road-direction correspond to the target road. In the present implementation, specific knowledge contained in the entities may be acquired from the knowledge graph. For example, for the target road, the accessible road-direction corresponding to the target road may be acquired.

In the present implementation, the executing body may also retrieve an entity in the established knowledge graph, and may further retrieve an entity associated with the retrieved entity. It may be understood that the knowledge graph is a knowledge graph related to the guide arrow sign and the accessible road-direction corresponding to the target road.

In the present implementation, the knowledge graph may be established by using the guide arrow sign and the accessible road-direction corresponding to the target road as the entities of the knowledge graph, and using the relationship between the guide arrow sign and the accessible road-direction as the relationship between the entities of the knowledge graph, such that the specific knowledge contained in the entities may be subsequently retrieved from the established knowledge graph.

In some optional implementations of the present embodiment, the road test data may include at least one of the following: a road type of the target road, user feedback data for the accessible road-direction, a turning angle at the intersection of the target road, and an instruction of a signal light located on the target road.

In the present implementation, the road type of the target road may be a special lane, which may be a lane whose accessible direction will change in different time periods; for example, a bus-only lane, a tidal-type lane, a time-limited one-way lane, a time-limited banned lane, a variable lane, a shared lane, or a high-occupancy vehicle lane (HOV).

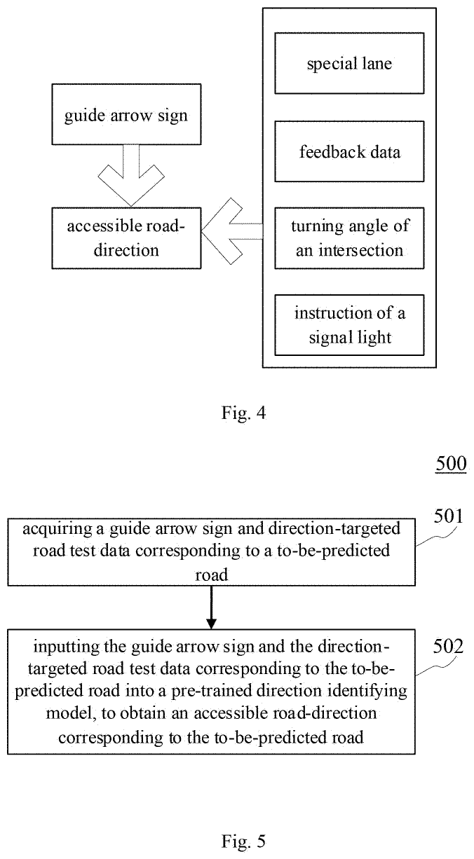

In an example, in FIG. 4, the guide arrow sign corresponding to the target road is labelled based on a guide arrow identifying model or manually; then the accessible road-direction corresponding to the target road is obtained by the direction identifying model based on the direction-targeted road test data and the guide arrow sign.

It should be noted that the guide arrow identifying model may be obtained by training based on a guide arrow and a corresponding category tag.

Here, the user feedback data for the accessible road-direction may be user feedback data submitted for the accessible road-direction of the target road; and/or user feedback data for the guide arrow sign.

In an example, the user on the target road provides a feedback on the accessible road-direction of the target road as “turn left” through his/her terminal device.

Here, the instruction of the signal light on the target road may be an instruction outputted by a highlighting signal light indicating a left turn.

In the present implementation, the guide arrow identifying model may be obtained by training based on at least one of: a road type of the target road, user feedback data for the accessible road-direction, a turning angle of an intersection of the target road, and an instruction of a signal light located on the target road, as well as the guide arrow sign and the accessible road-direction.

Further referring to FIG. 5, FIG. 5 shows a process 500 of a method for identifying an accessible road-direction according to an embodiment of the present disclosure. The method for identifying an accessible road-direction may include the following steps.

Step 501: acquiring a guide arrow sign and direction-targeted road test data corresponding to a to-be-predicted road.

In the present embodiment, an executing body (e.g., the terminal devices 101, 102, and 103, or the server 105 shown in FIG. 1) of the method for identifying an accessible road-direction may acquire the guide arrow sign and the direction-targeted road test data corresponding to the to-be-predicted road. The to-be-predicted road may be a road in an actual road network or a road in an electronic map, and for the to-be-predicted road, a direction identifying model may be used for identifying an accessible road-direction corresponding to the to-be-predicted road. The to-be-predicted road may be a road that has not been predicted in the actual road network or the electronic map.

It should be noted that the executing body of the method for identifying the accessible road-direction may be the same as or different from the executing body of the method for generating a direction identifying model.

Step 502: inputting the guide arrow sign and the direction-targeted road test data corresponding to the to-be-predicted road into a pre-trained direction identifying model, to obtain an accessible road-direction corresponding to the to-be-predicted road.

In the present embodiment, the executing body may input the guide arrow sign and the direction-targeted road test data corresponding to the to-be-predicted road into the direction identifying model, to obtain the accessible road-direction corresponding to the to-be-predicted road.

It should be noted that the pre-trained direction identifying model may be a model obtained by training in accordance with the above method for generating a direction identifying model.

The method for identifying an accessible road-direction provided in the embodiment of the present disclosure may determine the accessible road-direction corresponding to the to-be-predicted road by the direction identifying model.

In some optional implementations of the present embodiment, the accessible road-direction and the guide arrow sign corresponding to the to-be-predicted road are displayed on a display screen of an electronic device.

In the present implementation, after obtaining the accessible road-direction corresponding to the to-be-predicted road, the executing body may display the accessible road-direction and the guide arrow sign corresponding to the to-be-predicted road on the display screen of the electronic device.

In an example, the method for identifying an accessible road-direction further includes: generating a corresponding reminding message.

The reminding message may be a voice reminding message, to remind a traffic participant of a travelling direction at a next moment by voice. The reminding message may further be a highlighted-display reminding message, to remind the traffic participant to pay attention to the travelling direction at the next moment.

It should be noted that, in actual use, the voice reminding approach and the highlighted-display reminding approach may be used in combination to adapt to different application scenarios.

In the present implementation, the accessible road-direction and the guide arrow sign corresponding to the to-be-predicted road may be displayed on the display screen of the electronic device, to guide the traffic participant in the travelling direction on the to-be-predicted road at the next moment, thereby reminding the traffic participant in advance to drive in accordance with the guide arrow sign and the accessible road-direction.

In some optional implementations of the present embodiment, the method for identifying an accessible road-direction may further include:

storing an ID (identity document) of the to-be-predicted road as an external key, and the guide arrow sign and the accessible road-direction as an attribute content in a preset knowledge graph.

In an example, in FIG. 6, NAV_GUIDE_INFO is used for storing information of the guide arrow sign, and is attached to the to-be-predicted road, the external key is an ID (IN_ROAD_ID) of the to-be-predicted road, and a primary key is all guide arrow guides (INFO_ID) on the to-be-predicted road. The attribute content includes the guide arrow sign (ARR_INFO) and the accessible road-direction (TURN_INFO). NAV_ROAD is used for characterizing a road link of the to-be-predicted road. A group of guide arrows are bound to an incoming road link, through which a main table (i.e., a table where the NAV_GUIDE_INFO is located) may be inquired, and which has a relationship of 1:1 with the main table. NAV_LANE_TOPO is a group of guide arrow guides (i.e., guide arrows and accessible road-directions) among all guide arrow guides on the to-be-predicted road, the guide arrow guides are used for guiding a traffic participant to travel on the to-be-predicted road in accordance with the guide arrows and the accessible road-directions, and have a relationship of 1:N with the main table. N is equal to the number of groups of the guide arrow guides, the primary key is TOPO_ID (a group of guide arrow guides), the external key is the ID (IN_ROAD_ID) of the to-be-predicted road entering a table where the NAV_LANE_TOPO is located, the external key is an ID (OUT_ROAD_ID) of the to-be-predicted road exiting the table where the NAV_LANE_TOPO is located, the external key is INFO_ID (all guide arrow guides), and the attribute content includes whether there is manual intervention (IS_MANUAL) or the direction identifying model (TURN_INFO) is used; where the manual intervention may be the manual correction of the accessible road-direction. The ID of the to-be-predicted road contains the establishment of the relationship between entering the to-be-predicted road and exiting the to-be-predicted road, and is therefore used as the external key.

In the present implementation, the executing body may store the ID (identity document) of the to-be-predicted road as the external key, and the guide arrow sign and the accessible road-direction as the attribute content, thus achieving the storage of the guide arrow sign and the accessible road-direction.

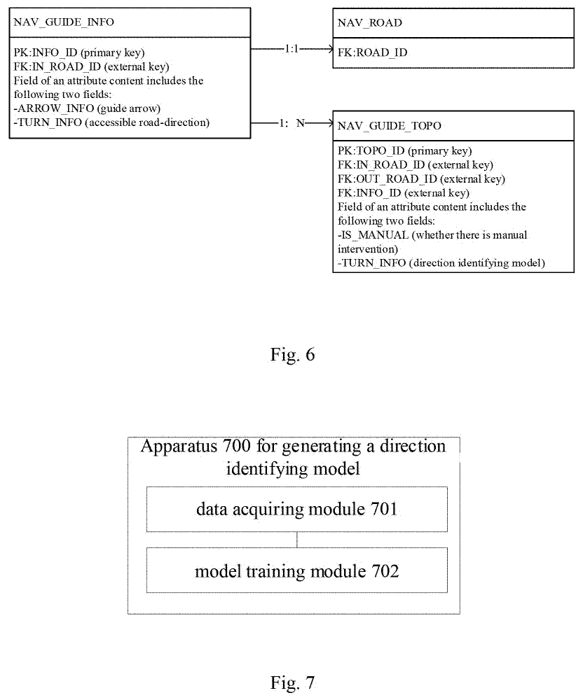

Further referring to FIG. 7, as an implementation of the method shown in the above figures, an embodiment of the present disclosure provides an apparatus for generating a direction identifying model. The embodiment of the apparatus corresponds to the embodiment of the method shown in FIG. 2, and the apparatus may be specifically applied to various electronic devices.

As shown in FIG. 7, the apparatus 700 for generating a direction identifying model of the present embodiment may include: a data acquiring module 701 and a model training module 702. The data acquiring module 701 is configured to acquire direction-targeted road test data corresponding to a target road, and a guide arrow sign and an accessible road-direction corresponding to the target road; and the model training module 702 is configured to train a machine learning model by using the road test data and the guide arrow sign as an input of the direction identifying model, and using the accessible road-direction as an output of the direction identifying model, to obtain the direction identifying model.

The related description of steps 201 to 202 in the corresponding embodiment of FIG. 2 may be referred to for specific processing of the data acquiring module 701 and the model training module 702 in the apparatus 700 for generating a direction identifying model in the present embodiment and the technical effects thereof, respectively. The description will not be repeated here.

In some optional implementations of the present embodiment, the apparatus 700 for generating a direction identifying model in the present embodiment further includes: a direction acquiring module configured to acquire the accessible road-direction corresponding to the target road from a preset knowledge graph based on the guide arrow sign corresponding to the target road.

In some alternative implementations of the present embodiment, the apparatus 700 for generating a direction identifying model in the present embodiment further includes: a graph establishing module configured to establish the knowledge graph by using the guide arrow sign and the accessible road-direction as entities, and based on a relationship between the guide arrow sign and the accessible road-direction.

In some alternative implementations of the present embodiment, the road test data includes at least one of: a road type of the target road, user feedback data for the accessible road-direction, a turning angle of an intersection of the target road, and an instruction of a signal light located on the target road.

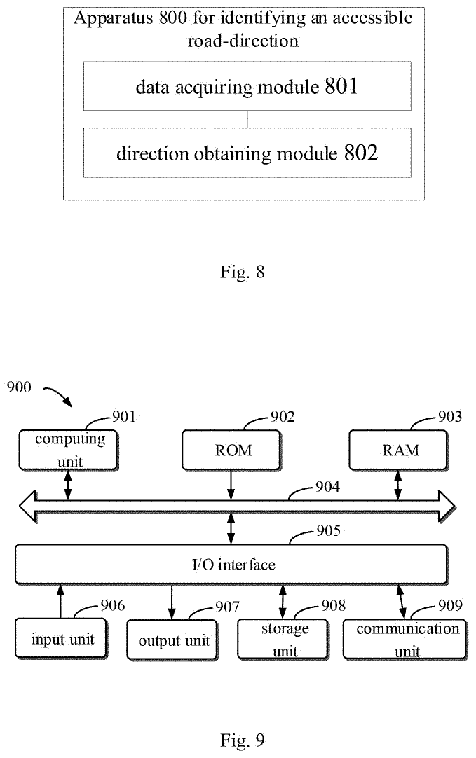

Further referring to FIG. 8, as an implementation of the method shown in the above figures, an embodiment of the present disclosure provides an apparatus for identifying an accessible road-direction. The embodiment of the apparatus corresponds to the embodiment of the method shown in FIG. 5, and the apparatus may be specifically applied to various electronic devices.

As shown in FIG. 8, the apparatus 800 for identifying an accessible road-direction of the present embodiment may include: a data acquiring module 801 and a direction obtaining module 802. The data acquiring module 801 is configured to acquire a guide arrow sign and direction-targeted road test data corresponding to a to-be-predicted road; and the direction obtaining module 802 is configured to input the guide arrow sign and the direction-targeted road test data corresponding to the to-be-predicted road into a pre-trained direction identifying model, to obtain an accessible road-direction corresponding to the to-be-predicted road.

The related description of steps 501 to 502 in the corresponding embodiment of FIG. 5 may be referred to for specific processing of the data acquiring module 801 and the direction obtaining module 802 in the apparatus 800 for identifying an accessible road-direction in the present embodiment and the technical effects thereof, respectively. The description will not be repeated here.

In some alternative implementations of the present embodiment, the apparatus 800 for identifying an accessible road-direction further includes: a display module configured to display the guide arrow sign and the accessible road-direction corresponding to the to-be-predicted road on a display screen of an electronic device.

In some alternative implementations of the present embodiment, the apparatus 800 for identifying an accessible road-direction further includes: a storing module configured to store, in a preset knowledge graph, an ID of the to-be-predicted road as an external key, and the guide arrow sign and the accessible road-direction corresponding to the to-be-predicted road as an attribute content.

According to embodiments of the present disclosure, the present disclosure further provides an electronic device, a readable storage medium, a computer program product, a roadside device, and a cloud control platform.

FIG. 9 shows a schematic block diagram of an example electronic device 900 that may be configured to implement embodiments of the present disclosure. The electronic device is intended to represent various forms of digital computers, such as a laptop computer, a desktop computer, a workbench, a personal digital assistant, a server, a blade server, a mainframe computer, and other suitable computers. The electronic device may further represent various forms of mobile apparatuses, such as a personal digital assistant, a cellular phone, a smart phone, a wearable device, and other similar computing apparatuses. The components shown herein, the connections and relationships thereof, and the functions thereof are used as examples only, and are not intended to limit implementations of the present disclosure described and/or claimed herein.

As shown in FIG. 9, the device 900 includes a computing unit 901, which may execute various appropriate actions and processes in accordance with a computer program stored in a read-only memory (ROM) 902 or a computer program loaded into a random-access memory (RAM) 903 from a storage unit 908. The RAM 903 may further store various programs and data required by operations of the device 900. The computing unit 901, the ROM 902, and the RAM 903 are connected to each other through a bus 904. An input/output (I/O) interface 905 is also connected to the bus 904.

A plurality of components in the device 900 is connected to the I/O interface 905, including: an input unit 906, such as a keyboard and a mouse; an output unit 907, such as various types of displays and speakers; a storage unit 908, such as a magnetic disk and an optical disk; and a communication unit 909, such as a network card, a modem, and a wireless communication transceiver. The communication unit 909 allows the device 900 to exchange information/data with other devices via a computer network such as the Internet and/or various telecommunication networks.

The computing unit 901 may be various general-purpose and/or special-purpose processing components having a processing power and a computing power. Some examples of the computing unit 901 include, but are not limited to, a central processing unit (CPU), a graphics processing unit (GPU), various special-purpose artificial intelligence (AI) computing chips, various computing units running a machine learning model algorithm, a digital signal processor (DSP), and any appropriate processor, controller, micro-controller, and the like. The computing unit 901 executes various methods and processes described above, such as the method for generating a direction identifying model or the method for identifying an accessible road-direction. For example, in some embodiments, the method for generating a direction identifying model or the method for identifying an accessible road-direction may be implemented as a computer software program that is tangibly included in a machine-readable medium, such as the storage unit 908. In some embodiments, some or all of the computer programs may be loaded and/or installed onto the device 900 via the ROM 902 and/or the communication unit 909. When the computer programs are loaded into the RAM 903 and are executed by the computing unit 901, one or more steps of the method for generating a direction identifying model or the method for identifying an accessible road-direction described above may be executed. Alternatively, in other embodiments, the computing unit 901 may be configured to execute the method for generating a direction identifying model or the method for identifying an accessible road-direction by any other appropriate approach (e.g., by means of firmware).

Various implementations of the systems and technologies described above herein may be implemented in a digital electronic circuit system, an integrated circuit system, a field programmable gate array (FPGA), an application specific integrated circuit (ASIC), an application specific standard product (ASSP), a system on chip (SOC), a complex programmable logic device (CPLD), computer hardware, firmware, software, and/or a combination thereof. The various implementations may include: an implementation in one or more computer programs that are executable and/or interpretable on a programmable system including at least one programmable processor, which may be a special-purpose or general-purpose programmable processor, and may receive data and instructions from, and transmit data and instructions to, a storage system, at least one input apparatus, and at least one output apparatus.

Program codes for implementing the method of the embodiments of the present disclosure may be compiled using any combination of one or more programming languages. The program codes may be provided to a processor or controller of a general-purpose computer, a special-purpose computer, or other programmable data processing apparatuses, such that the program codes, when executed by the processor or controller, cause the functions/operations specified in the flow charts and/or block diagrams to be implemented. The program codes may be completely executed on a machine, partially executed on a machine, partially executed as a separate software package on a machine and partially executed on a remote machine, or completely executed on a remote machine or server.

In the context of the present disclosure, the machine-readable medium may be a tangible medium which may contain or store a program for use by, or used in combination with, an instruction execution system, apparatus or device. The machine-readable medium may be a machine-readable signal medium or a machine-readable storage medium. The machine-readable medium may include, but is not limited to, electronic, magnetic, optical, electromagnetic, infrared, or semiconductor systems, apparatuses, or devices, or any appropriate combination of the above. A more specific example of the machine-readable storage medium will include an electrical connection based on one or more pieces of wire, a portable computer disk, a hard disk, a random-access memory (RAM), a read-only memory (ROM), an erasable programmable read-only memory (EPROM or flash memory), an optical fiber, a portable compact disk read-only memory (CD-ROM), an optical storage device, a magnetic storage device, or any appropriate combination of the above.

To provide interaction with a user, the systems and technologies described herein may be implemented on a computer that is provided with: a display apparatus (e.g., a CRT (cathode ray tube) or a LCD (liquid crystal display) monitor) configured to display information to the user; and a keyboard and a pointing apparatus (e.g., a mouse or a trackball) by which the user can provide an input to the computer. Other kinds of apparatuses may be further configured to provide interaction with the user. For example, a feedback provided to the user may be any form of sensory feedback (e.g., visual feedback, auditory feedback, or haptic feedback); and an input may be received from the user in any form (including an acoustic input, a voice input, or a tactile input).

The systems and technologies described herein may be implemented in a computing system (e.g., as a data server) that includes a back-end component, or a computing system (e.g., an application server) that includes a middleware component, or a computing system (e.g., a user computer with a graphical user interface or a web browser through which the user can interact with an implementation of the systems and technologies described herein) that includes a front-end component, or a computing system that includes any combination of such a back-end component, such a middleware component, or such a front-end component. The components of the system may be interconnected by digital data communication (e.g., a communication network) in any form or medium. Examples of the communication network include: a local area network (LAN), a wide area network (WAN), and the Internet.

The computer system may include a client and a server. The client and the server are generally remote from each other, and usually interact via a communication network. The relationship between the client and the server arises by virtue of computer programs that run on corresponding computers and have a client-server relationship with each other.

In the context of the present disclosure, the roadside device may include not only the above electronic device, but also a communication component and the like. The electronic device and the communication component may be integrated, or may be provided separately. The electronic device may acquire data, e.g., direction-targeted road test data, from a sensing device (e.g., a roadside camera), where the road test data may be, e.g., a picture or a video, thereby performing road test data processing and data computing. Alternatively, the electronic device itself may further have a sensing data acquisition function and a communication function, such as an artificial intelligence (AI) camera, and the electronic device may perform image and video processing and data computing directly based on the acquired sensing data.

In the context of the present disclosure, the cloud control platform performs processing in cloud, and the electronic device included in the cloud control platform may acquire data, e.g., the road test data, from the sensing device (e.g., the roadside camera), thereby performing road test data processing and data computing. The cloud control platform may also be referred to as a vehicle-road synergy management platform, an edge computing platform, a cloud computing platform, a central system, a cloud server, and the like.

Artificial intelligence is a subject of studying computers to simulate some human thinking processes and intelligent behaviors (such as learning, reasoning, thinking, and planning), and includes both hardware technologies and software technologies. The hardware technologies of artificial intelligence generally include technologies, such as sensors, dedicated artificial intelligence chips, cloud computing, distributed storage, and big data processing; and the software technologies of artificial intelligence mainly include several major directions, such as a computer vision technology, a speech recognition technology, a natural speech processing technology, machine learning/deep learning, a big data processing technology, and a knowledge graph technology.

It should be understood that the various forms of processes shown above may be used to reorder, add, or delete steps. For example, the steps disclosed in the present disclosure may be executed in parallel, sequentially, or in different orders, as long as the desired results of the technical solutions mentioned in the present disclosure can be implemented. This is not limited herein.

The above specific implementations do not constitute any limitation to the scope of protection of the present disclosure. It should be understood by those skilled in the art that various modifications, combinations, sub-combinations, and replacements may be made according to the design requirements and other factors. Any modification, equivalent replacement, improvement, and the like made within the spirit and principle of the present disclosure should be encompassed within the scope of protection of the present disclosure.

What is claimed is:

1. A method for generating a direction identifying model, comprising:
acquiring direction-targeted road test data corresponding to a target road, a guide arrow sign corresponding to the target road, and an accessible road-direction corresponding to the target road; and
training a machine learning model by using the direction-targeted road test data and the guide arrow sign as an input of the direction identifying model, and using the accessible road-direction as an output of the direction identifying model, to obtain the direction identifying model.

2. The method according to claim 1, wherein before acquiring the direction-targeted road test data corresponding to the target road, and the guide arrow sign and the accessible road-direction corresponding to the target road, the method further comprises:
acquiring the accessible road-direction corresponding to the target road from a preset knowledge graph based on the guide arrow sign corresponding to the target road.

3. The method according to claim 2, wherein the method further comprises:
establishing the preset knowledge graph by using the guide arrow sign and the accessible road-direction as entities, and based on a relationship between the guide arrow sign and the accessible road-direction.

4. The method according to claim 1, wherein the direction-targeted road test data comprises at least one of: a road type of the target road, user feedback data for the accessible road-direction, a turning angle of an intersection of the target road, and an instruction of a signal light located on the target road.

5. The method according to claim 1, the method comprising:
acquiring a guide arrow sign and direction-targeted road test data corresponding to a to-be-predicted road; and
inputting the guide arrow sign and the direction-targeted road test data corresponding to the to-be-predicted road into the direction identifying model, to obtain an accessible road-direction corresponding to the to-be-predicted road.

6. The method according to claim 5, wherein the method further comprises: displaying the guide arrow sign and the accessible road-direction corresponding to the to-be-predicted road on a display screen of an electronic device.

7. The method according to claim 5, wherein the method further comprises:
storing, in a preset knowledge graph, an ID of the to-be-predicted road as an external key, and the guide arrow sign and the accessible road-direction corresponding to the to-be-predicted road as an attribute content.

8. An apparatus for generating a direction identifying model, comprising:
at least one processor; and
a memory storing instructions, wherein the instructions when executed by the at least one processor, cause the at least one processor to perform operations, the operations comprising:
acquiring direction-targeted road test data corresponding to a target road, a guide arrow sign corresponding to the target road, and an accessible road-direction corresponding to the target road; and
training a machine learning model by using the direction-targeted road test data and the guide arrow sign as an input of the direction identifying model, and using the accessible road-direction as an output of the direction identifying model, to obtain the direction identifying model.

9. The apparatus according to claim 8, wherein before acquiring the direction-targeted road test data corresponding to the target road, and the guide arrow sign and the accessible road-direction corresponding to the target road, the operations further comprise:
acquiring the accessible road-direction corresponding to the target road from a preset knowledge graph based on the guide arrow sign corresponding to the target road.

10. The apparatus according to claim 9, wherein the operations further comprise:
establishing the preset knowledge graph by using the guide arrow sign and the accessible road-direction as entities, and based on a relationship between the guide arrow sign and the accessible road-direction.

11. The apparatus according to claim 8, wherein the direction-targeted road test data comprises at least one of: a road type of the target road, user feedback data for the accessible road-direction, a turning angle of an intersection of the target road, and an instruction of a signal light located on the target road.

12. The apparatus according to claim 8, wherein the operations further comprise:
acquiring a guide arrow sign and direction-targeted road test data corresponding to a to-be-predicted road; and
inputting the guide arrow sign and the direction-targeted road test data corresponding to the to-be-predicted road into the direction identifying model, to obtain an accessible road-direction corresponding to the to-be-predicted road.

13. The apparatus according to claim 12, wherein the operations further comprise:
displaying the guide arrow sign and the accessible road-direction corresponding to the to-be-predicted road on a display screen of an electronic device.

14. The apparatus according to claim 12, wherein the operations further comprise:
storing, in a preset knowledge graph, an ID of the to-be-predicted road as an external key, and the guide arrow sign and the accessible road-direction corresponding to the to-be-predicted road as an attribute content.

15. A non-transitory computer readable storage medium storing computer instructions, wherein the computer instructions are used for causing a computer to execute operations comprising:
acquiring direction-targeted road test data corresponding to a target road, a guide arrow sign corresponding to the target road, and an accessible road-direction corresponding to the target road; and
training a machine learning model by using the direction-targeted road test data and the guide arrow sign as an input of a direction identifying model, and using the accessible road-direction as an output of the direction identifying model, to obtain the direction identifying model.

16. The non-transitory computer readable storage medium according to claim 15, wherein before acquiring the direction-targeted road test data corresponding to the target road, and the guide arrow sign and the accessible road-direction corresponding to the target road, the operations further comprise:
acquiring the accessible road-direction corresponding to the target road from a preset knowledge graph based on the guide arrow sign corresponding to the target road.

17. The non-transitory computer readable storage medium according to claim 16, wherein the operations further comprise:
establishing the preset knowledge graph by using the guide arrow sign and the accessible road-direction as entities, and based on a relationship between the guide arrow sign and the accessible road-direction.

18. The non-transitory computer readable storage medium according to claim 15, wherein the direction-targeted road test data comprises at least one of: a road type of the target road, user feedback data for the accessible road-direction, a turning angle of an intersection of the target road, and an instruction of a signal light located on the target road.

19. A roadside device, comprising the apparatus according to claim 8.

20. A cloud control platform, comprising the apparatus according to claim 8.
